(19) United States
(12) Patent Application Publication
(10) Pub. No.: US 2025/0337815 A1
(43) Pub. Date: Oct. 30, 2025

(54) ENHANCED SERVICE DISCOVERY OF EDGE APPLICATION SERVER

(71) Applicants: Zongrui Ding, Portland, OR (US); Alexandre Saso Stojanovski, Paris (FR); Chang Hong Shan, Shanghai (CN); Qian Li, Beaverton, OR (US)

(72) Inventors: Zongrui Ding, Portland, OR (US); Alexandre Saso Stojanovski, Paris (FR); Chang Hong Shan, Shanghai (CN); Qian Li, Beaverton, OR (US)

(21) Appl. No.: 19/263,647

(22) Filed: Jul. 9, 2025

Related U.S. Application Data
(60) Provisional application No. 63/669,115, filed on Jul. 9, 2024.

(51) Int. Cl. H04L 67/51

(52) U.S. Cl. CPC H04L 67/51

(57) ABSTRACT

An apparatus and method for enhanced service discovery of edge application servers in next-generation wireless communication systems are disclosed. The apparatus includes a user equipment (UE) having a processor that enables interactions with network functions for service discovery. The system leverages edge application server discovery functions (EASDF) and control plane enhancements, such as access and mobility functions (AMF) and service orchestration and chaining functions (SOCF), for discovery and interaction with edge application servers.

### PRIORITY CLAIM

This application claims the benefit of priority to U.S. Provisional Patent Application Ser. No. 63/669,115, filed Jul. 9, 2024, which is incorporated herein by reference in its entirety.

### TECHNICAL FIELD

Embodiments pertain to wireless networks and wireless communications. Some embodiments relate to systems for service discovery mechanisms for edge application servers.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various user equipment (UEs) and applications. The evolution of wireless communication networks has resulted in increasingly intricate and interconnected systems that combine traditional connectivity with advanced computational capabilities. These systems operate within a distributed framework where computing resources are positioned closer to end users. This structure supports the delivery of services across a wide variety of devices and applications, often requiring low-latency and high-efficiency interactions. Modern networks operate in dynamic environments where the allocation of resources is required to adapt to varying conditions and demands. The distributed nature of these systems introduces complexities in managing interactions between users and network resources, particularly in scenarios in which rapid response times and precise service delivery are desirable. The ability to effectively coordinate these interactions is influenced by the diverse and evolving requirements of applications.

In such environments, the dynamic nature of resource availability and the variability of service requirements present ongoing challenges. The distributed placement of computing resources across multiple network nodes adds further complexity to aligning resource capabilities with application demands. These factors contribute to the broader challenges faced in ensuring efficient and reliable operation within modern communication networks.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 shows edge application server (EAS) discovery using an Edge Application Server Discovery Function (EASDF), according to some examples.

FIG. 4 shows Service Discovery via Control Plane (access and mobility function (AMF) enhanced for Computing Service Discovery), according to some examples.

FIG. 5 shows Service Discovery via Control Plane (service orchestration and chaining function (SOCF) for service discovery and orchestration), according to some examples.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

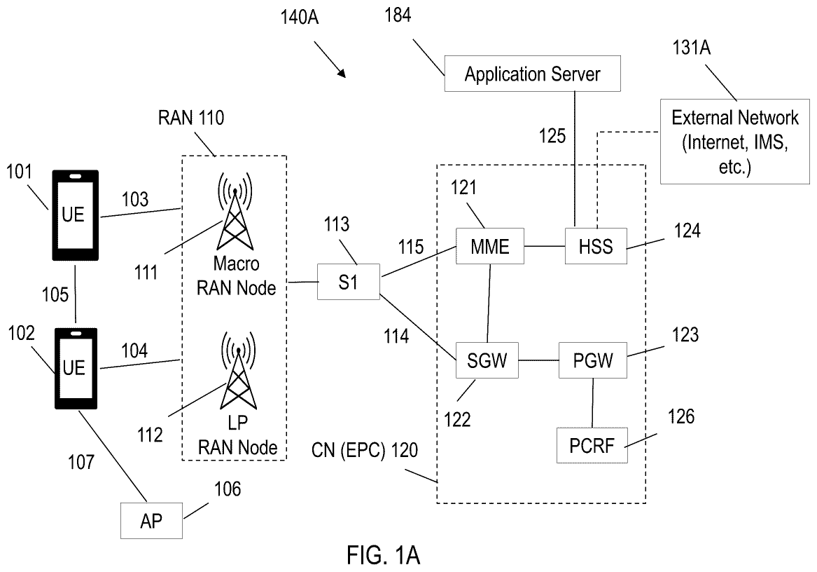

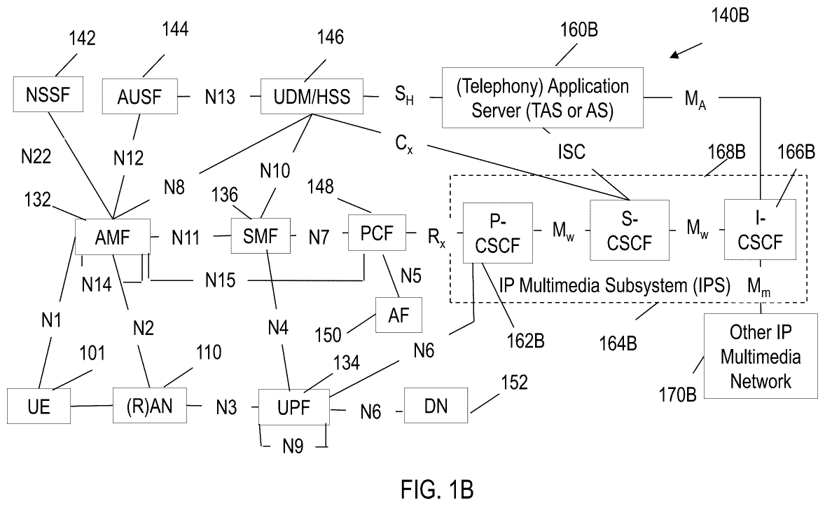

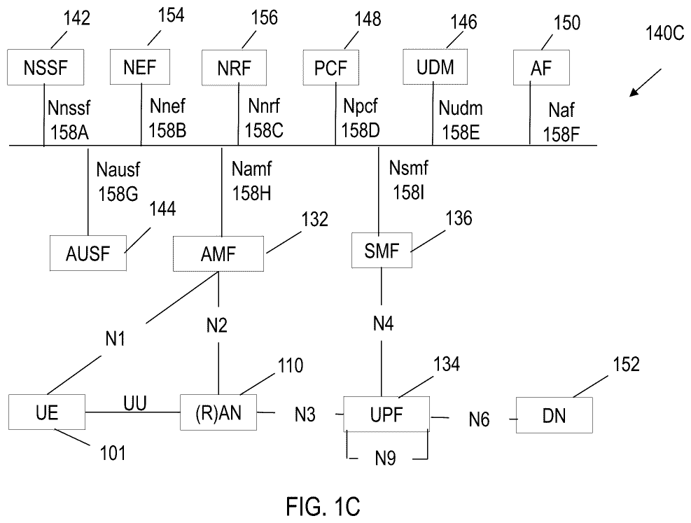

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfil various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signalling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

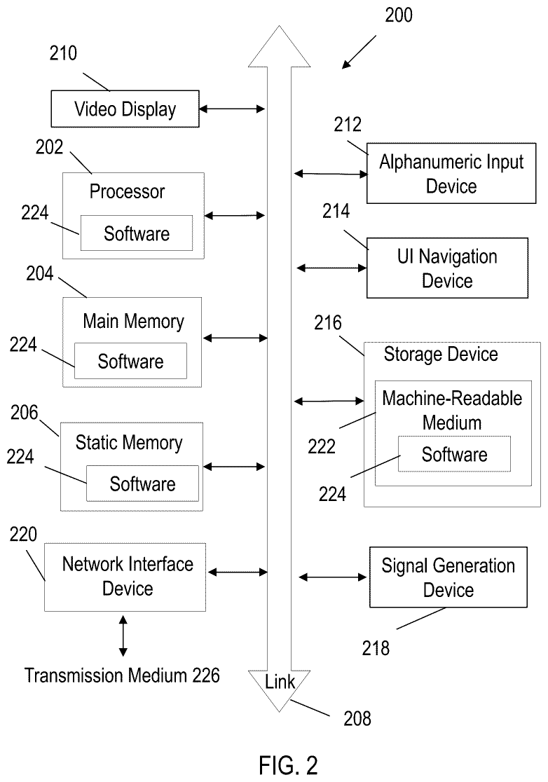

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, systems operating in distributed environments may use computing resources that are positioned closer to UEs to support low-latency, high-efficiency interactions. However, the dynamic nature of resource availability and the variability of service requirements present ongoing challenges in ensuring efficient and reliable service discovery for edge application servers (EAS). Existing approaches to EAS discovery, such as those defined in 3GPP TS 23.548 and TS 23.558, rely heavily on user plane (UP)-based mechanisms, including domain name server (DNS)-based resolution or pre-configured filters. These methods are limited in their ability to dynamically adapt to changing conditions or provide rich contextual information about the computing resources, often resulting in suboptimal service discovery outcomes. For instance, DNS-based solutions lack the granularity to account for specific application requirements, while filter-based approaches depend on static pre-configurations and spatial validity triggers, which are not sufficiently dynamic for modern, highly variable network environments.

The system herein introduces a service discovery mechanism that leverages the control plane (CP) for enhanced interaction between the UE and network functions. This approach enables dynamic and context-aware discovery of computing resources and services, mitigating pre-established packet data unit (PDU) session use. The AMF is enhanced with a SOCF or the SOCF is used as a standalone function, which allows the AMF or SOCF to interact with the UE to exchange capabilities, discover computing resources, and orchestrate services based on real-time requirements. By incorporating rich contextual information, such as hardware/software capabilities, application-specific requirements, and quality of service (QoS) parameters, the most suitable EAS is identified and configured to meet the demands of the UE.

The identification and configuration involve a series of steps, including the exchange of computing capabilities between the UE and the AMF, a Service Repository Function (SRF) may be used for resource discovery and service identifiers (IDs) and data network names (DNNs) may be dynamically allocated to facilitate PDU session establishment. Additionally, the SOCF can directly interact with Edge Enabler Servers (EES) or leverage Operations, Administration, and Maintenance (OAM) systems for lifecycle management and configuration of the EAS. This architecture not only improves the efficiency and accuracy of service discovery but also supports advanced use cases such as artificial intelligence/machine learning (AI/ML) workloads, federated learning, and extended reality (XR) applications.

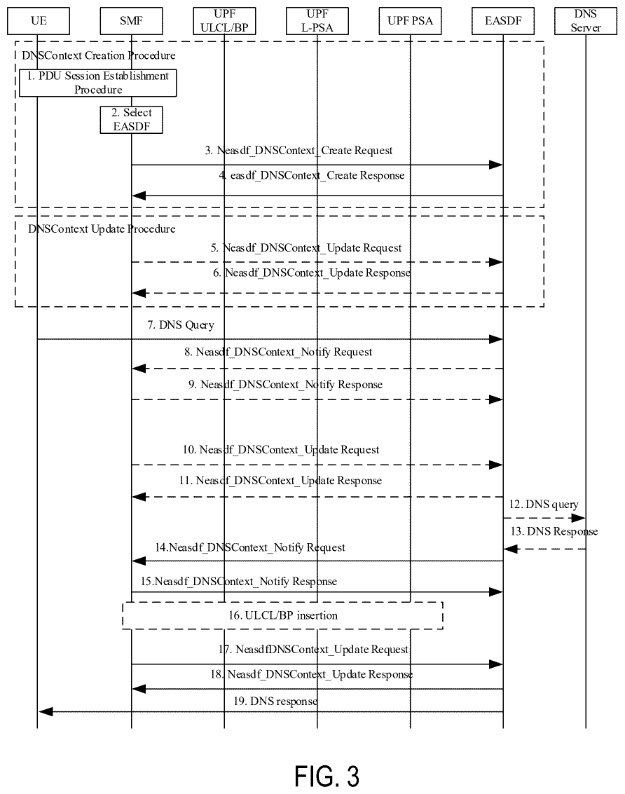

FIG. 3 shows EAS discovery using an EASDF, according to some examples. In FIG. 3, the EASDF is specified to act as a DNS resolver for the UE via the UP to find a suitable EAS, e.g., close to the UE's location. This approach for service discovery is UE-agnostic and uses BaselineDNSPattern data created by the SMF to treat the DNS queries/responses for matching and handling rules, as shown. The approach is based on a DNS that does not include rich information about the EAS so that the discovered EAS may not be able to serve the application client (AC) on the UE, thus causing the EAS discovery to trigger again.

As shown, in step 1, the UE sends PDU Session Establishment Request to the SMF as shown in step 1 of clause 4.3.2.2.1 of TS 23.502. The SMF retrieves the UE subscription information from the UDM (which may include an indication on UE authorization for EAS discovery via EASDF) and checks if the UE is authorized to discover the EAS via EASDF. If not authorized, this procedure is terminated, and the subsequent steps are skipped.

2. During the PDU Session Establishment procedure, the SMF selects the EASDF as described clause 6.3 of TS 23.501. The SMF may consider the UE subscription information to select an EASDF as the DNS server of the PDU Session. The SMF may indicate to the UE either that for the PDU Session the use of the EDC functionality is allowed or that for the PDU Session the use of the EDC functionality is required. If the SMF, based on local configuration, decides that the interaction between EASDF and DNS Server in the DN goes via the PSA UPF, the SMF configures PSA UPF within N4 rules to forward the DNS message between EASDF and DN.

3. The SMF invokes Neasdf_DNSContext_Create Request (UE IP address, DNN, notification endpoint, (DNS message handling rules)) to the selected EASDF. This step is performed before step 11 of PDU Session Establishment procedure in clause 4.3.2.2.1 of TS 23.502. The EASDF creates a DNS context for the PDU Session and stores the UE IP address, the notification endpoint and potentially provided DNS message handling rule(s) into the context. The EASDF is provisioned with the DNS message handling rule(s), before the DNS Query message is received at the EASDF or as a consequence of the DNS Query reporting.

4. The EASDF invokes the service operation Neasdf_DNSContext_Create Response and if it exists, provides EASDF DNS security information. After this step, the SMF includes the IP address of the EASDF as DNS server/resolver for the UE in the PDU Session Establishment Accept message as defined in step 11 of clause 4.3.2.2.1 of TS 23.502. The UE configures the EASDF as DNS server for that PDU Session. If the UE requested to obtain UE IP address via DHCP and the SMF supports DHCP based IP address configuration, the SMF responds to the UE via DHCP response with the allocated UE IP address and/or the DNS server address containing the IP address of the EASDF.

5. The SMF may invoke Neasdf_DNSContext_Update Request (EASDF Context ID, (DNS message handling rules)) to EASDF. The update may be triggered by UE mobility, e.g. when the UE moves to a new location, or by a reporting by EASDF of a DNS Query with certain FQDN, or, the update may be triggered by insertion/removal of Local PSA, e.g. to update rules to handle DNS messages from the UE or by new PCC rule information.

6. The EASDF responds with Neasdf_DNSContext_Update Response.

7. If required, the Application in the UE uses the EDC functionality as described in clause 6.2.4 of TS 23.548 to send the DNS Query to the EASDF. The UE sends a DNS Query message to the EASDF.

8. If the DNS Query message matches a DNS message detection template of DNS message handling rule for reporting, the EASDF sends the DNS message report to the SMF by invoking Neasdf_DNSContext_Notify Request (information from the DNS Query e.g. a target FQDN of the DNS Query). The EASDF may add a DNS message identifier in the Neasdf_DNSContext_Notify. The DNS message identifier uniquely identifies the DNS message reported and is used to associate the corresponding DNS message handling rule included in Neasdf_DNSContext_Update Request with the identified DNS message. The DNS message identifier is generated by EASDF.

9. The SMF responds with Neasdf_DNSContext_Notify Response.

10. If DNS message handling rule for the FQDN received in the report need to be updated, e.g. provide updates to information to build/replace the EDNS Client Subnet option information, the SMF invokes Neasdf_DNSContext_Update Request (DNS message handling rules) to the EASDF. If the EASDF provided a DNS message identifier, the SMF adds this DNS message identifier to the corresponding DNS message handling rule included in Neasdf_DNSContext_Update. If the EASDF did not provide a DNS message identifier, the SMF may use the DNS message type (Request) and the target FQDN to uniquely identify the DNS message. For Option A, the DNS handling rule includes corresponding IP address to be used to build/replace the EDNS Client Subnet option. For Option B, the DNS handling rule includes corresponding Local DNS Server IP address. The EASDF may as well be instructed by the DNS handling rule to simply forward the DNS Query to a pre-configured DNS server/resolver.

11. If the SMF provided a DNS message handling rule with DNS message identifier, the EASDF only applies the DNS message handling rule to the corresponding DNS message. The EASDF responds with Neasdf_DNSContext_Update Response.

12. The EASDF handles the DNS Query message received from the UE as the following:
For Option A, the EASDF adds/replaces the EDNS Client Subnet option into the DNS Query message and sends it to C-DNS server;
For Option B, the EASDF removes the EDNS Client Subnet option if received in the DNS query and sends the DNS Query message to the Local DNS server.

If no DNS message detection template within the DNS message handling rule provided by the SMF matches the requested FQDN in the DNS Query, the EASDF may simply send a DNS Query to a pre-configured DNS server/resolver.

13. EASDF receives the DNS Response including EAS IP addresses which is determined by the DNS system and determines that the DNS Response can be sent to the UE.

14. The EASDF sends DNS message reporting to the SMF by invoking Neasdf_DNSContext_Notify request including EAS information if the EAS IP address or the FQDN in the DNS Response message matches the DNS message detection template provided by the SMF. The DNS message reporting may contain multiple EAS IP addresses if the EASDF has received multiple EAS IP address(es) from the DNS server it has contacted. The DNS message reporting may contain the FQDN and the EDNS Client Subnet option received in the DNS Response message. The EASDF may also add a DNS message identifier to the reporting. The DNS message identifier uniquely identifies the DNS response reported, and the EASDF can associate the corresponding DNS message handling rule included in Neasdf_DNSContext_Update Request with the identified DNS response. The DNS message identifier is generated by the EASDF.

Per the received DNS message handling rule, the EASDF does not send the DNS Response message to the UE but waits for SMF instructions (in step 17), i.e. buffering the DNS Response message.

If the DNS Response(s) is required to be buffered and reported to the SMF, when the reporting-once control information is set, the EASDF only reports to the SMF once by invoking Neasdf_DNSContext_Notify request for DNS Responses matching with the DNS message detection template.

15. The SMF invokes Neasdf_DNSContext_Notify Response service operation.

16. The SMF may perform UL CL/BP and Local PSA selection and insert UL CL/BP and Local PSA.

Based on EAS information received from the EASDF in Neasdf_DNSContext_Notify, other UPF selection criteria, as specified in clause 6.3.3 in TS 23.501, and possibly Service Experience or DN performance analytics for an Edge Application as described in TS 23.288, the SMF may determine the DNAI. The SMF may also determine the associated N6 traffic routing information for the DNAI according to N6 traffic routing information for the DNAI included in EAS Deployment Information and configure Local PSA UPF with forwarding actions derived from the N6 traffic routing information. The SMF may perform UL CL/BP and Local PSA selection, and insertion as described in TS 23.502. In case of UL CL, the traffic detection rules and traffic routing rules are determined by the SMF based on IP address range(s) per DNAI included in the EAS Deployment Information or according to PCC rule received from PCF or according to preconfigured information.

17. The SMF invokes Neasdf_DNSContext_Update Request (DNS message handling rules). If the EASDF provided a DNS message identifier, the SMF adds this to the corresponding DNS message handling rule included in Neasdf_DNSContext_Update Request. If the EASDF did not provide a DNS message identifier, the SMF may use the DNS message type (Response) and the FQDN to uniquely identify the DNS response message. The DNS message handling rule with the Control Action “Send the buffered DNS response(s) message to UE” indicates the EASDF to send DNS Response(s) buffered in step 14 to UE. Other DNS message handling rules may indicate the EASDF not to send further DNS Response message(s) corresponding to FQDN ranges and/or EAS IP address ranges.

18. If the SMF provided a DNS message handling rule with DNS message identifier, the EASDF only applies the DNS message handling rule to the corresponding DNS response. The EASDF responds with Neasdf_DNSContext_Update Response.

19. If indicated to send the buffered DNS response(s) to the UE in step 17, the EASDF sends the DNS Response(s) to the UE and handles the EDNS Client Subnet option as described above. During PDU Session Release procedure, the SMF removes the DNS context by invoking Neasdf_DNSContext_Delete service.

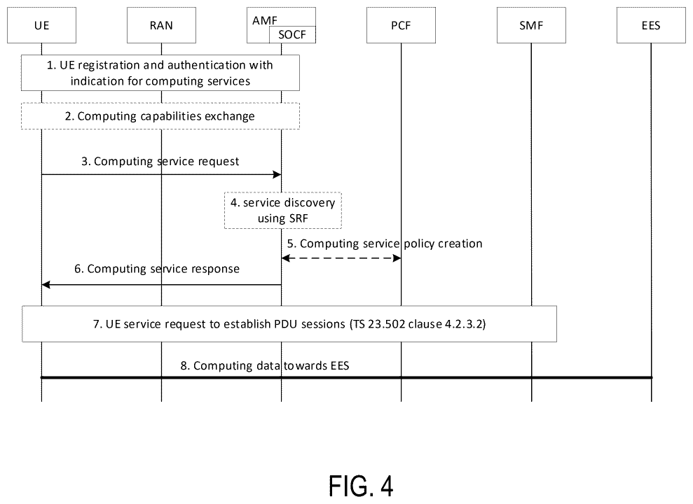

To improve the operations shown in FIG. 3, the service discovery for computing services via control plane, e.g., EAS discovery, may be used so that the AMF or a new function can interact with the UE to exchange capabilities and discover computing resource/services. The AMF or the new function can 1) provide a DNN to the UE for establishing a PDU session or 2) interact with SMF to establish a PDU session. The function for service discovery and orchestration for computing resource/service can be an enhancement to the AMF named SOCF. The UE may or may not establish PDU sessions before initiating service discovery and orchestration. FIG. 4 shows Service Discovery via the CP (AMF-enhanced for Computing Service Discovery), according to some examples. FIG. 4 thus shows a process in which the AMF is enhanced to handle service discovery and orchestration, acting as the main point of interaction with the UE.

Step 1: the UE registers with the AMF with an indication of using computing resource/services in the network. The AMF performs authentication to check the subscription of the UE to computing resource/service in the PLMN.

Step 2: the UE exchanges computing capabilities with the AMF which can include the hardware/software (HW/SW) type, capacity, target computing resource/service, AI/ML capabilities, etc. This step can be combined with Step 1 as a non-access stratum (NAS) parameter. The capability exchange request includes the UE capability. The capability exchange response includes the computing capabilities of the network, such as xPU, speed, and maximum capacity of storage or whether dynamic orchestration between the UE and network is allowed.

Step 3: the UE sends a computing service request to the AMF indicating the computing resource/service requested including the information about the computing service such as the service type (e.g., AI/ML service, federated learning, serverless, XR) or the FQDN list towards the EASs and the information about service orchestration such as computing environment with library, the QoS of the service in terms of latency, data rate, requirements on mobility, etc. This information can be carried as a NAS parameter.

Step 4: the AMF may use a standalone SRF to discover suitable computing resource/service for the UE. The input of the SRF is the information received in Step 3 from the UE and any additional requirements that the AMF can impose on this service discovery, such as location of the service.

Step 5: the AMF can create a policy related to the requested QoS of the computing service and the PDU session. A service ID may then be allocated to this service.

Step 6: the AMF sends a computing service response to the UE indicating the discovered computing resource/service. This message can include a DNN and Single—Network Slice Selection Assistance Information (S-NSSAI) for the UE to set up a PDU session that points to a special computing node or location or network slice. This message can also include the QoS identifier such as an enhanced 5G QoS Identifier (5QI) for computing service, the IP address and port number for the discovered computing resource/service of the EES. The service ID allocated in Step 5 can be included to identify the policy for the computing service.

Step 7: the UE sends a service request with the DNN and service ID received in Step 6 to establish a PDU session. The SMF can bind the policy by looking up the PCF using the service ID allocated in Step 5.

Step 8: the computing related data is exchanged between the UE and EES via the UP (the UPF is not shown).

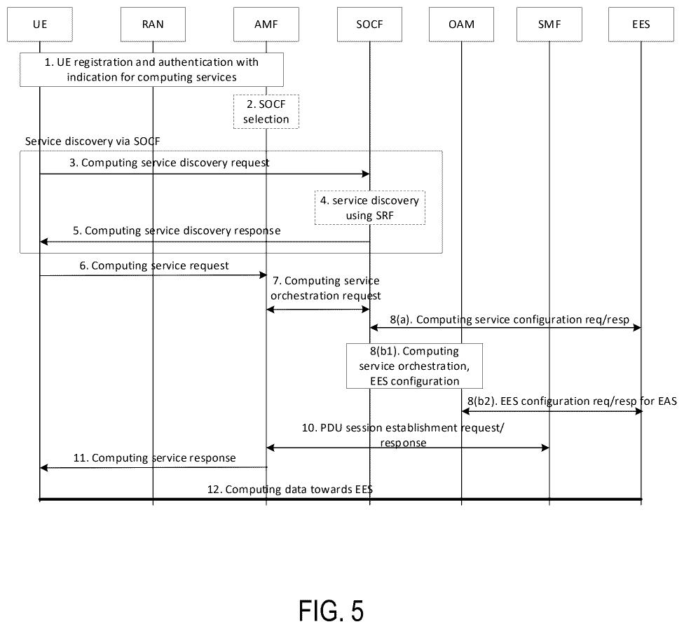

Rather than using the AMF, however, the SOCF may be a standalone function for service discovery and interaction with the EES directly or via OAM for EES configuration and EAS LCM. FIG. 5 shows Service Discovery via the CP (SOCF) for service discovery and orchestration, according to some examples. FIG. 5 thus introduces a dedicated SOCF that can directly manage, configure, and orchestrate edge resources and services, providing more advanced and flexible service orchestration capabilities.

Step 1: the UE registers with the AMF with an indication of using computing resource/services in the network. The AMF performs authentication to check the subscription of the UE to computing resource/service in the PLMN.

Step 2: the AMF may perform SOCF selection based on location or the NRF.

Step 3-5: the UE performs service discovery with the SOCF in a manner similar to FIG. 4 Steps 3-6. As in FIG. 4, the PCF is not shown.

Step 6: the UE sends a service request to the AMF with an indication for computing service, the DNN and service ID received from the SOCF in Step 5.

Step 7: the AMF sends the computing service orchestration request to the SOCF with the service ID and the information received in Step 5 about computing service requirements for the SOCF to generate configurations to configure the EES.

Step 8(a): the SOCF sends a computing service configuration request to the EES to prepare for the requested computing service, such as EAS LTM, computing resource preparation and computing task setup. The EES sends a response to confirm the configuration has been accepted or rejected.

Step 8(b1): alternatively, the SOCF sends a request to the OAM for service orchestration, such as EAS LTM, computing resource preparation and computing task set up to configure the EES.

Step 8(b2): the OAM configures the EES as requested in Step 8(b1).

Step 10: the AMF sends a PDU session establishment request using the DNN and service ID received in Step 5 to establish PDU sessions for the computing service.

Step 11: the AMF sends the computing service response to the UE indicating the discovered computing resource/service. The information sent may be similar to that in Step 6 of FIG. 4.

Step 12: the computing related data is exchanged between the UE and EES via the UP (the UPF is not shown).

Thus, the architecture and orchestration of the service discovery process for edge application servers is different between FIGS. 4 and 5. FIG. 4 illustrates a process in which the AMF is enhanced to support service discovery and orchestration for computing resources and services. In this approach, the AMF acts as the central orchestrator. The UE registers with the AMF, indicating computing resources or services are to be used, and exchanges information about its capabilities and requirements, such as H/W features, AI/ML capabilities, and QoS. The UE then sends a computing service request to the AMF, which may consult a SRF to identify suitable resources or services. The AMF can create a policy and allocate a service ID for the requested service, and then responds to the UE with details about the discovered resource or service, including the DNN, S-NSSAI, QoS identifier, and service ID. The UE uses this information to request PDU session establishment, after which data exchange with the edge server occurs via the UP. In this model, the AMF is responsible for orchestrating service discovery, policy creation, and resource selection, and the process can occur before PDU session establishment.

In contrast, FIG. 5 introduces a SOCF as a standalone function, which provides a more advanced and flexible orchestration framework. Here, the AMF may select a SOCF based on location or information from the NRF. The UE then performs service discovery directly with the SOCF, exchanging requirements and capabilities in a manner similar to the AMF-based process. The SOCF provides the UE with the DNN, S-NSSAI, and service ID. The UE subsequently sends a service request to the AMF with the information received from the SOCF. The AMF then forwards a service orchestration request to the SOCF, including the service requirements and service ID. The SOCF is responsible for configuring the EES for the requested service, either directly or via OAM systems, which may involve LCM, resource preparation, or task setup. The AMF initiates PDU session establishment for the computing service. This architecture allows the SOCF to directly manage and configure edge resources and their lifecycles, supporting more advanced orchestration, chaining, and dynamic configuration of edge services.

Various examples include the UE receiving, from the network function (AMF or SOCF), an indication of a dynamically allocated service identifier that is used to bind a policy for the computing service in a PCF. The UE may also receive, from the network function, a DNN and a S-NSSAI that are specific to a network slice optimized for the requested computing service. In certain scenarios, the UE may transmit a request for a specific type of computing service, such as AI/ML training, AI/ML inference, federated learning, serverless computing, or XR services. The network function may provide the UE with a QoS identifier that is enhanced for computing service requirements, as well as an IP address and port number for the discovered computing resource or service.

The service discovery and orchestration process may support dynamic re-selection or handover to a different computing resource or service based on changes in UE location, network conditions, or service requirements. The UE may receive information indicating that the computing resource or service is prepared for the requested computing environment, including pre-provisioned libraries or runtime environments, and may also receive an indication that the computing resource or service has been configured via an OAM system. In some cases, the UE may transmit a request for service discovery that includes a list of candidate FQDNs for edge application servers and may receive a list of candidate EASs or EESs from the network function, allowing the UE to select one based on application-specific criteria.

The UE may perform authentication with the network function using subscription information specific to computing services in the PLMN. The network function may also provide notifications of LCM events related to the computing resource or service. In further embodiments, the UE may support service discovery and orchestration for a plurality of computing services in parallel, each associated with a different service identifier and policy. The network function may provide information about the availability, load, or proximity of candidate computing resources or services to optimize service selection. Additionally, the UE may transmit a request for service discovery that includes a preference for edge, cloud, or hybrid computing environments, enabling flexible and context-aware resource selection.

Thus, the use of UP and DNS-based mechanisms for EAS and EES discovery is limited by use of simple identifiers and lacks the ability to account for UE-specific requirements, such as stringent QoS or workload capabilities. Moreover, the dependence on pre-established PDU sessions and static configurations lead to inefficiencies, particularly in scenarios involving UE mobility, often resulting in repeated or back-and-forth discovery procedures.

Instead of relying on such mechanisms, a CP-based service discovery and orchestration mechanism that operates before PDU session establishment is introduced, enabling a richer and more context-aware exchange of information between the UE and the network. Notably, the capability exchange between the UE and the network encompasses not only hardware and software capabilities but also supports collaborative workload execution, where portions of the workload may be distributed between the UE and the network. The SRF, analogous to the NRF in 5G, is used as a repository for detailed information about computing services, capabilities, and workloads, facilitating more precise service discovery.

To this end, a SOCF may be implemented within the AMF or as a standalone function. The SOCF is capable of interacting with OAM systems to request the deployment or lifecycle management of EAS/EES instances, including the ability to trigger new deployments if a requested service is unavailable. The control plane approach also allows for the dynamic assignment of service identifiers, which are used to bind policies and PDU session parameters, thereby streamlining session establishment and minimizing the need for subsequent modifications.

Additionally, the inclusion of service IDs, FQDNs, and network slice identifiers in the PDU session establishment request is supported, enabling precise and policy-driven session setup. The orchestration process can further include the selection of the optimal UPF anchor based on service requirements and SRF responses. Overall, the architecture supports more efficient and lower-latency service discovery and session setup compared to the prior art, as the control plane interaction occurs prior to PDU session establishment. The SOCF orchestration capabilities are extensible to include EAS lifecycle management, resource preparation, and task setup, either directly or via OAM, enabling a flexible and dynamic orchestration framework that supports advanced use cases such as on-demand deployment and chaining of edge services.

### Examples

Example 1 is an apparatus for a user equipment (UE), the apparatus comprising: a memory configured to store parameters for service discovery and communication; and a processor to configure the UE to: transmit, to a network function of a next generation (NG) network over a control plane (CP), a service discovery request that includes, information indicating a computing service requirement, the network function including at least one of an access and mobility management function (AMF) that contains a service orchestration and chaining function (SOCF) or a standalone SOCF; receive, from the network function, a service discovery response comprising information identifying a computing resource or service available in the NG network; and initiate establishment of a communication session with the computing resource or service based on the information.

In Example 2, the subject matter of Example 1 includes, wherein the service discovery request comprises at least one of: a fully qualified domain name (FQDN) list, a service type, or a set of computing environment requirements.

In Example 3, the subject matter of Examples 1-2 includes, wherein the information identifying the computing resource or service comprises at least one of: a data network name (DNN), a single network slice selection assistance information (S-NSSAI), a service identifier, a quality of service (QoS) parameter, or an internet protocol (IP) address.

In Example 4, the subject matter of Examples 1-3 includes, wherein: the processor further configures the UE to exchange capability information with the network function prior to establishment of a packet data unit (PDU) session, and the capability information comprises at least one of: hardware capability, software capability, artificial intelligence/machine learning (AI/ML) capability, or collaborative workload execution capability between the UE and the NG network.

In Example 5, the subject matter of Examples 1-4 includes, wherein: the processor further configures the UE to receive, from the network function, a policy or service identifier for binding to the communication session, and at least one of: the policy is dynamically created based on the computing service and orchestration requirements, or the service identifier is dynamically allocated and used to bind the policy in a policy control function (PCF).

In Example 6, the subject matter of Examples 1-5 includes, wherein the processor further configures the UE to initiate establishment of a packet data unit (PDU) session with the computing resource or service using the information.

In Example 7, the subject matter of Examples 1-6 includes, wherein: the processor further configures the UE to transmit, to the network function in the service discovery request, information about orchestration requirements, and the information about orchestration requirements includes at least one of: latency, data rate, or mobility requirements.

In Example 8, the subject matter of Examples 1-7 includes, wherein: the computing resource comprises at least one of an edge application server (EAS) or edge enabler server (EES), and the information is determined based on real-time context and dynamic resource discovery.

In Example 9, the subject matter of Examples 1-8 includes, wherein the network function includes the standalone SOCF, which is configured to interact with an edge enabler server (EES) or an operations, administration, and maintenance (OAM) system for dynamic configuration and lifecycle management of the computing resource or service, including on-demand instantiation if a requested service is unavailable.

In Example 10, the subject matter of Examples 1-9 includes, wherein the processor further configures the UE to authenticate, with the network function, a subscription of the UE to computing resources or services in the NG network prior to service discovery.

Example 11 is an apparatus for a service orchestration and chaining function (SOCF), the apparatus comprising: a memory configured to store service discovery and orchestration parameters; and a processor to configure the SOCF to: receive, from at least one of a user equipment (UE) or an access and mobility management function (AMF) over a control plane (CP), a service discovery request comprising information of a computing service requirement and orchestration requirement; determine, based on the information, a computing resource or service available in a next generation (NG) network; generate a service discovery response comprising information identifying the suitable computing resource or service; and transmit the service discovery response to the at least one of the UE or AMF for establishment of a communication session with the computing resource or service.

In Example 12, the subject matter of Example 11 includes, wherein the SOCF is integrated within the AMF.

In Example 13, the subject matter of Examples 11-12 includes, wherein the SOCF is implemented as a standalone network function.

In Example 14, the subject matter of Examples 11-13 includes, wherein the processor further configures the SOCF to interact with an edge enabler server (EES) or an operations, administration, and maintenance (OAM) system to configure the computing resource or service.

In Example 15, the subject matter of Examples 11-14 includes, wherein the processor further configures the SOCF to allocate a dynamically generated service identifier for the computing service and to bind a policy for the computing service in a policy control function using the service identifier, and the service identifier is included in a packet data unit (PDU) session establishment request.

In Example 16, the subject matter of Examples 11-15 includes, wherein the processor further configures the SOCF to provide, to the AMF, configuration information for establishment of a packet data unit (PDU) session between the UE and the computing resource or service.

In Example 17, the subject matter of Examples 11-16 includes, wherein the processor further configures the SOCF to receive, from the AMF, a request to orchestrate or chain multiple computing resources or services for the UE, and to generate orchestration instructions for configuring the computing resource or service accordingly.

In Example 18, the subject matter of Examples 11-17 includes, wherein the processor further configures the SOCF to monitor lifecycle management (LCM) events related to the computing resource or service and to provide notifications of the LCM events to the at least one of the AMF or UE.

Example 19 is a non-transitory computer-readable storage medium that stores instructions for execution by one or more processors of an apparatus of a user equipment (UE), the instructions, when executed, cause the UE to: transmit, to a network function of a next generation (NG) network over a control plane (CP), a service discovery request that includes, information indicating a computing service requirement, the network function including at least one of an access and mobility management function (AMF) that contains a service orchestration and chaining function (SOCF) or a standalone SOCF; receive, from the network function, a service discovery response comprising information identifying a computing resource or service available in the NG network; and initiate establishment of a communication session with the computing resource or service based on the information.

In Example 20, the subject matter of Example 19 includes, wherein the instructions, when executed, cause the UE to at least one of: exchange capability information with the network function prior to establishment of a packet data unit (PDU) session, the capability information comprising at least one of: hardware capability, software capability, or artificial intelligence/machine learning (AI/ML) capability, or receive, from the network function, a policy or service identifier for binding to the communication session, and at least one of: the policy is dynamically created based on the computing service and orchestration requirements, or the service identifier is dynamically allocated and used to bind the policy in a policy control function (PCF).

In Example 21, the subject matter of Examples 1-20 includes, wherein the network function queries a service repository function (SRF) that stores detailed information about available computing services, capabilities, and workloads, and selects a computing resource or service for the UE based on a context-aware match between UE requirements and stored information.

In Example 22, the subject matter of Examples 1-21 includes, wherein the processor is further configured to support dynamic re-selection or handover to a different computing resource or service based on changes in UE location, network conditions, or service requirements, by repeating a CP-based service discovery process.

In Example 23, the subject matter of Examples 1-22 includes, wherein a service identifier, fully qualified domain name (FQDN), and network slice identifier are included in a packet data unit (PDU) session establishment request, enabling a session management function (SMF) to bind the session to a specific policy and user plane function (UPF) anchor for the computing resource or service.

In Example 24, the subject matter of Examples 11-23 includes, wherein the SOCF is further configured to trigger, via an operations, administration, and maintenance (OAM) system, deployment of a new edge application server (EAS) or edge enabler server (EES) instance if no existing resource satisfies UE service requirements.

In Example 25, the subject matter of Examples 11-24 includes, wherein the SOCF is further configured to orchestrate chaining of multiple computing resources or services to fulfil a composite service request from the UE, and to provide corresponding configuration and policy information to the AMF and a session management function (SMF).

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE), the apparatus comprising:
a memory configured to store parameters for service discovery and communication; and
a processor to configure the UE to:
transmit, to a network function of a next generation (NG) network over a control plane (CP), a service discovery request that includes information indicating a computing service requirement, the network function including at least one of an access and mobility management function (AMF) that contains a service orchestration and chaining function (SOCF) or a standalone SOCF;
receive, from the network function, a service discovery response comprising information identifying a computing resource or service available in the NG network; and
initiate establishment of a communication session with the computing resource or service based on the information.

2. The apparatus of claim 1, wherein the service discovery request comprises at least one of: a fully qualified domain name (FQDN) list, a service type, or a set of computing environment requirements.

3. The apparatus of claim 1, wherein the information identifying the computing resource or service comprises at least one of: a data network name (DNN), a single network slice selection assistance information (S-NSSAI), a service identifier, a quality of service (QoS) parameter, or an internet protocol (IP) address.

4. The apparatus of claim 1, wherein:
the processor further configures the UE to exchange capability information with the network function prior to establishment of a packet data unit (PDU) session, and
the capability information comprises at least one of: hardware capability, software capability, artificial intelligence/machine learning (AI/ML) capability, or collaborative workload execution capability between the UE and the NG network.

5. The apparatus of claim 1, wherein:
the processor further configures the UE to receive, from the network function, a policy or service identifier for binding to the communication session, and
at least one of:
the policy is dynamically created based on the computing service and orchestration requirements, or
the service identifier is dynamically allocated and used to bind the policy in a policy control function (PCF).

6. The apparatus of claim 1, wherein the processor further configures the UE to initiate establishment of a packet data unit (PDU) session with the computing resource or service using the information.

7. The apparatus of claim 1, wherein:
the processor further configures the UE to transmit, to the network function in the service discovery request, information about orchestration requirements, and
the information about orchestration requirements includes at least one of: latency, data rate, or mobility requirements.

8. The apparatus of claim 1, wherein:
the computing resource comprises at least one of an edge application server (EAS) or edge enabler server (EES), and
the information is determined based on real-time context and dynamic resource discovery.

9. The apparatus of claim 1, wherein the network function includes the standalone SOCF, which is configured to interact with an edge enabler server (EES) or an operations, administration, and maintenance (OAM) system for dynamic configuration and lifecycle management of the computing resource or service, including on-demand instantiation if a requested service is unavailable.

10. The apparatus of claim 1, wherein the processor further configures the UE to authenticate, with the network function, a subscription of the UE to computing resources or services in the NG network prior to service discovery.

11. An apparatus for a service orchestration and chaining function (SOCF), the apparatus comprising:
a memory configured to store service discovery and orchestration parameters; and
a processor to configure the SOCF to:
receive, from at least one of a user equipment (UE) or an access and mobility management function (AMF) over a control plane (CP), a service discovery request comprising information of a computing service requirement and orchestration requirement;
determine, based on the information, a computing resource or service available in a next generation (NG) network;
generate a service discovery response comprising information identifying the computing resource or service; and
transmit the service discovery response to the at least one of the UE or AMF for establishment of a communication session with the computing resource or service.

12. The apparatus of claim 11, wherein the SOCF is integrated within the AMF.

13. The apparatus of claim 11, wherein the SOCF is implemented as a standalone network function.

14. The apparatus of claim 11, wherein the processor further configures the SOCF to interact with an edge enabler server (EES) or an operations, administration, and maintenance (OAM) system to configure the computing resource or service.

15. The apparatus of claim 11, wherein the processor further configures the SOCF to allocate a dynamically generated service identifier for the computing service and to bind a policy for the computing service in a policy control function using the service identifier, and the service identifier is included in a packet data unit (PDU) session establishment request.

16. The apparatus of claim 11, wherein the processor further configures the SOCF to provide, to the AMF, configuration information for establishment of a packet data unit (PDU) session between the UE and the computing resource or service.

17. The apparatus of claim 11, wherein the processor further configures the SOCF to receive, from the AMF, a request to orchestrate or chain multiple computing resources or services for the UE, and to generate orchestration instructions for configuring the computing resource or service accordingly.

18. The apparatus of claim 11, wherein the processor further configures the SOCF to monitor lifecycle management (LCM) events related to the computing resource or service and to provide notifications of the LCM events to the at least one of the AMF or UE.

19. A non-transitory computer-readable storage medium that stores instructions for execution by one or more processors of an apparatus of a user equipment (UE), the instructions, when executed, cause the UE to:
transmit, to a network function of a next generation (NG) network over a control plane (CP), a service discovery request that includes information indicating a computing service requirement, the network function including at least one of an access and mobility management function (AMF) that contains a service orchestration and chaining function (SOCF) or a standalone SOCF;
receive, from the network function, a service discovery response comprising information identifying a computing resource or service available in the NG network; and
initiate establishment of a communication session with the computing resource or service based on the information.

20. The non-transitory computer-readable storage medium of claim 19, wherein the instructions, when executed, cause the UE to at least one of:
exchange capability information with the network function prior to establishment of a packet data unit (PDU) session, the capability information comprising at least one of: hardware capability, software capability, or artificial intelligence/machine learning (AI/ML) capability, or
receive, from the network function, a policy or service identifier for binding to the communication session, and at least one of: the policy is dynamically created based on the computing service and orchestration requirements, or the service identifier is dynamically allocated and used to bind the policy in a policy control function (PCF).
